(19) United States
(12) Patent Application Publication
(10) Pub. No.: US 2010/0277280 A1
(43) Pub. Date: Nov. 4, 2010

(54) Systems and methods for relaying information with RFID tags

(76) Inventors: Scott M. Burkart, Royse City, TX (US); Ken A. Stroud, Greenville, TX (US); Jonathan E. Brown, Farmersville, TX (US); James K. Burgess, III, Edmond, OK (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 12/387,489

(22) Filed: May 1, 2009

(51) Int. Cl. H04Q 5/22

(52) U.S. Cl. 340/10.1

(57) ABSTRACT

Data from one or more sensors may be collected using a first band of a multi-band RFID tag device and then passed on to a remote receiver from the RFID tag device using a second RF band. This capability may be employed to allow a first band-equipped RFID tag to collect data from local sensors, and then to report that data over a second band link, allowing the RFID tag device to function as an intermediary bridge device or relay between the sensor/s and a remote receiver and/or tag interface device. Such a remote receiver may further be in communication with a remote network so that the RFID tag device acts to bridge local sensor data to a remote network, where it may be further processed aid/or accessed by one or more users. The RFID tag device may also be interactive in nature, meaning that the tag data storage and/or the tag's operation is reprogrammable in the operational environment.

### FIELD OF THE INVENTION

This invention relates generally to radio-frequency identification (RFID), and more particularly to RFID communication systems.

### BACKGROUND OF THE INVENTION

As defined by the FCC, an ultra-wideband (UWB) signal is an antenna transmission in the range of 3.1 GHz up to 10.6 GHz at a limited transmit power of −41.3 dBm/MHz with an emitted signal bandwidth that exceeds the lesser of 500 MHz or 20% of the center frequency. UWB signals are currently employed for high-bandwidth, short range communications that use high bandwidth radio energy that is pulsed at specific time instants.

Applications for FCC-defined UWB transmissions include distance-based location and tracking applications, and localization techniques that employ precision time-of-arrival measurements. Examples of such UWB applications include radio frequency identification (RFID) tags that employ UWB communication technology for tracking, localization and transmitting information. Other types of UWB applications include precision radar imaging technology. Inventory tracking has been implemented through the use of passive, active and semi-passive RFID devices. These devices have widespread use, and typically respond to interrogation or send data at fixed intervals.

A high density active radio frequency identification (aRFID) environment can easily exceed 1000 aRFID tags for certain application installations, such as cattle feedlot applications where individual cows are each tagged with an aRFID tag. Currently, aRFID installations such as these may be implemented using a maximum of approximately 1000 aRFID tags per each RFID receiver that is provided for the installation. However, aRFID environments may routinely contain in excess of 40,000 tags within a 1 to 2 sq mile area. One previous attempt that has been made to reliably receive and process tag data, and to perform geolocation calculations in such environments, is to use software-only coding schemes in order to help distinguish between multiple tags. This method typically works up to the point where available bandwidth is exceeded due to the number of bits being transmitted (˜100 bits per tag transmission) and the number of tags in the environment (˜1000). Existing RFID tag geolocation technologies employ RFID tags which typically report data at a fixed rate, which is acceptable for low tag density environments (i.e., tag density less than approximately 1000) where interleaved and colliding packets are not problematic.

It is known to transmit data from embedded sensors over wired networks or short range wireless links.

### SUMMARY OF THE INVENTION

Disclosed herein are systems and methods for RFID tag operation. The disclosed systems and methods may be implemented in a variety of applications (e.g., asset or inventory tracking, sensor networks, geolocation devices, etc.) and may be implemented using passive, active and/or semi-passive RFID tag devices that respond to interrogation and/or send data at fixed intervals. Unlike conventional RFID systems, the disclosed systems and methods may be further implemented in one exemplary embodiment using field programmable or re-programmable RFID tag devices that are interactive.

In one exemplary embodiment, the disclosed systems and methods may be implemented to track a wide variety of one or more objects (e.g., for asset or inventory tracking) using a RFID tag device that is capable of changing behavior and/or changing onboard stored tag data based on interactions with tag interface devices such as a remote interrogating unit (e.g., an active RFID interrogator (aRFIDI) system), a handheld unit, a communication bridging device, a local interrogating unit (e.g., an interrogating device that is in relatively close proximity to the RFID tag device as compared to a remote interrogating unit), sensors in close proximity to the RFID tag device, etc. In a further embodiment, the RFID tag device may use FM-based communications (e.g., Narrow Band Frequency Modulation (NBFM)) as a first band for programmability and/or interrogation, and may use UWB-based communications as a second band to report data.

However implemented, each RFID tag device may have a unique identifier that is associated with an object to which it is associated (e.g., attached or otherwise coupled) such that the location of the RFID tag is representative of the location of the object. In this manner, a user or other entity may readily identify the current location of a particular object, based on the location of its associated transmitting RFID tag. Further, the RFID tag device may be configured to be removably associated with an object, e.g., so that the RFID tag device may be associated with a first object and tracked for a period of time with the associated first object, and then removed from association with the first object and then re-associated with a second object and tracked for a period of time with the associated second object, etc. Examples of such first and second objects with which a RFID tag device may removably associated include, but are not limited to, first and second livestock animals (e.g., cows), first and second inventory objects (e.g., shipping boxes or crates), etc.

In one embodiment, a multi-band RFID tag system may be configured as a tag having a first band (e.g., narrow band such as NBFM) transceiver, e.g., for interrogation and/or to allow field programmability of tag behavior and onboard tag data. The first band may be multiple channel-based, meaning that the RF spectrum of the first frequency band is broken up or divided into a plurality of separate channels, and first band communications may be achieved by the RFID tag system between any two devices of the system using a subset of the channels within the first band (e.g., a single one of the channels, two of the channels, etc.) and/or in narrow band fashion by using a sub-set of the channels within the band, e.g., using less than three of the channels. In this way, a first channel of the first band may be used for communication between a first pair of system devices and a second channel of the first band may be used for communication between a second pair of system devices. Such a multi-band RFID tag system may be further configured to have a second band (e.g., wide band such as UWB) transmitter, e.g., for responding to RFID interrogation signals from an interrogator. The second band may be non-channel based, meaning that the RF spectrum of the second frequency band is not broken up or divided up into separate channels, but rather the communication signals are spread across the second frequency band such that the undivided second band may be used by the RFID tag system for all second band communications between devices of the system. One example of a multiple channel-based first band is a NBFM frequency band having a plurality (e.g., 50) channels, and one example of a non channel-based second band is a pulse-based frequency band such as UWB.

The RFID tag system may be configured to collect data from one or more local sensors (e.g., sensors in close proximity to the RFID tag such as positioned on or attached to or located within the object associated with the RFID tag) through the first band link and store data points of interest in onboard storage. The RFID tag system may also be configured to report such collected sensor data to a remote receiver over a second band (e.g., UWB) link and/or to report such collected sensor data to a tag interface device over a first band (e.g., NBFM) link. In high density environments, the RFID tag system may be configured to work in conjunction with a remote interrogating unit. A handheld device (with or without an associated communication bridging device), local interrogating unit or other local tag interface device that is located in close geographical proximity to an aRFID tag (e.g., deployed in the field with the aRFID tag) as compared to the more distant location of a geographically remote receiver may also be additionally or alternatively provided to communicate with such an aRFID tag. In such an embodiment, any of these remote or local tag interface devices may be enabled to retrieve or change data stored on the RFID tag and/or may be enabled to change the operation of the tag. Operations of such a RFID tag that may be changed include, but are not limited to, report rates for tag data, the methodology of interaction of the tag with local sensors, the power levels of the UWB and NBFM devices, etc.

In another embodiment, communication with a multi-band RFID tag device may be established using a third band (e.g., 802.11x WiFi wireless standard such as IEEE 802.11 a, b, g, or n) that is different than the first and second bands employed by the multi-band RFID system. Communication between the multi-band RFID tag device and the third band device may be enabled, for example, using a bidirectional communication bridging device that converts first band signals of the RFID tag device to third band signals of another device, and vice-versa. Examples of third band-capable devices that may be bridged for communication with the first band of a RFID tag device include WiFi devices such as smart phone, notebook computer, WLAN router or any other type of WiFi enabled device. In one example, a tag interface control device may be provided in the form of a WiFi-enabled handheld unit (e.g., smart phone) that communicates with a multi-band RFID tag through a bridging device using NBFM radio frequency (RF) communications to retrieve or change stored data and/or change the tag operation (e.g., change programming of the tag). In a further exemplary embodiment, such a WiFi-enabled handheld unit may be configured to be relatively small (e.g., capable of fitting on a person's belt or in a person's pants or shirt pocket), portable, and/or battery or wireless-powered.

In one exemplary embodiment, a RFID tag device may operate most of the time in sleep mode, during which the first band receiving capability of the RFID tag is turned off to save battery life. Such a RFID tag operates in sleep mode for the duration of a sleep cycle which is terminated by a relatively short awake cycle (during which the RFID tag listens for first band signals transmitted by an interrogator system), prior to returning to a sleep cycle. In a further embodiment, communication with such a sleeping RFID tag device may be established from a tag interface device (which may include a communication bridging device) ad hoc and in-between tag awake cycles (i.e., during a tag sleep cycle) by sending a wake-up signal pulse that provides enough energy to activate the circuitry of the sleeping RFID tag device. Alternatively, a tag interface device (including a bridging device) may be configured to continuously send a wake-up message signal for the duration of the default sleep cycle of a RFID tag device to notify any wakened and listening RFID tags in range of the wake up signal that the listening RFID tags should stay active for a longer period of time than the default length of their awake cycle so that the tag interface device may further initiate communications with a specific RFID tag/s.

In another exemplary embodiment, data from one or more embedded sensors may be collected using a first band of a multi-band RFID tag device (e.g., relatively shorter range NBFM communications) and then passed on to a remote receiver from the RFID tag device using a second RF band (e.g., relatively longer range UWB communications). This capability may be employed to allow a first band-equipped RFID tag to collect data from local sensors, and then to report that data over a second band link, allowing the RFID tag device to function as an intermediary bridge device or relay between the sensor/s and a remote receiver. Such a remote receiver may further be in communication with a remote network (e.g., corporate or governmental intranet, Internet, etc.) so that the RFID tag device acts to bridge local sensor data to a remote network, where it may be further processed and/or accessed by one or more users. The RFID tag device may also be interactive in nature, meaning that the tag data storage and/or the tag's operation is reprogrammable in the operational environment. In another exemplary embodiment, collected sensor data may also be passed on to a tag interface device from the RFID tag device using the first RF band (e.g., NBFM communications), for example, allowing a first band-equipped RFID tag to collect data from local sensors, and then to report that data over a first band link to a checkpoint device, handheld device (e.g., through a communication bridging device), interrogator device, etc.

In a further embodiment, a RFID system may be provided that includes one or more RFID tags and an array of embedded sensors that each report data to a receiver in the RFID tag via a first band transmitter included in the sensors. The RFID tag may then report this data to a remote receiver via a second RF band transmitter included in the RFID tag. The collected sensor data may be provided from the remote receiver to a remote network. Advantageously, this system and method for collecting and reporting sensor data may be implemented to collect and report large amounts of data (e.g., greater than about 1 MByte) from embedded sensors. Example applications for collecting and reporting sensor data in the above-described manner include, but are not limited to, asset or inventory tracking where it may be useful to employ embedded sensors placed within objects (e.g., assets, inventory items or livestock) to transmit data about the status/health of the objects (e.g., during shipping or storage) to a remote location and/or to a remote network.

In one respect, disclosed herein is a method of relaying information using a radio frequency identification (RFID) relay tag system, including: receiving first band RF signal communications at an RFID relay tag from at least one sensor, the received first band RF signal communications containing sensor data produced by the sensor; processing the received first band RF signal communications on the RFID relay tag to obtain the sensor data; and transmitting the obtained sensor data from the RFID relay tag in at least one of a first band RF signal communication, a second band RF signal communication, or a combination thereof The first band may be a multiple channel-based frequency band, the second band may be a non-channel based frequency band, and the RFID relay tag may be associated with an object.

In another respect, disclosed herein is a method of controlling sensor operation, including transmitting a command signal from a RFID relay tag that is associated with an object to at least one sensor by a first band RF signal communication, the command signal being effective to alter operation of the at least one sensor receiving the command signal from the RFID relay tag. The first band may be a multiple channel-based frequency band.

In another respect, disclosed herein is a RFID communication system, including: at least one sensor configured to produce sensor data and to transmit the produced sensor data within first band RF signal communications; a radio frequency identification (RFID) relay tag configured to receive the first band RF signal communications containing the produced sensor data from the at least one sensor, process the received first band RF signal communications on the RFID relay tag to obtain the produced sensor data, and transmit the obtained sensor data from the RFID relay tag in at least one of a first band RF signal communication, a second band RF signal communication, or a combination thereof. The first band may be a multiple channel-based frequency band, the second band may be a non-channel based frequency band, and the RFID relay tag may be configured to remain associated with an object as the object moves from one geographic location to another geographic location.

In another respect, disclosed herein is a RFID communication system, including: at least one sensor configured to produce sensor data; and a radio frequency identification (RFID) relay tag configured to transmit a command signal from the RFID relay tag to the at least one sensor by a first band RF signal communication, the command signal being effective to alter operation of the at least one sensor. The first band may be a multiple channel-based frequency band, and the RFID relay tag may be configured to remain associated with an object as the object moves from one geographic location to another geographic location.

### BRIEF DESCRIPTION OF THE DRAWINGS

FIG. 1 is a block diagram of an aRFID communication system according to one exemplary embodiment of the disclosed systems and methods.

FIG. 2 is a block diagram of circuitry for a multi-band aRFID tag according to one exemplary embodiment of the disclosed systems and methods.

FIG. 3 is a block diagram of checkpoint interface control device circuitry according to one exemplary embodiment of the disclosed systems and methods.

FIG. 4 is illustrates a tag interface control device communicating with an aRFID tag through communication bridging device according to one exemplary embodiment of the disclosed systems and methods.

FIG. 5 is a block diagram of a communication bridging device according to one exemplary embodiment of the disclosed systems and methods.

FIG. 6 is a block diagram of circuitry for a multi-band aRFID tag according to one exemplary embodiment of the disclosed systems and methods.

FIG. 7 is a block diagram of a multi-band aRFID communication system according to one exemplary embodiment of the disclosed systems and methods.

### DESCRIPTION OF ILLUSTRATIVE EMBODIMENTS

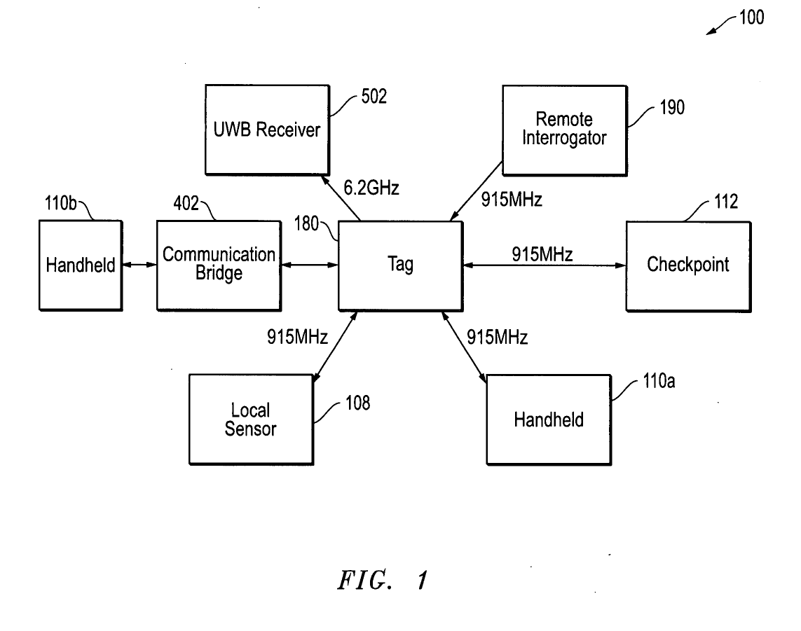

FIG. 1 illustrates an aRFID communication system 100 that includes an aRFID tag 180, an optional remote interrogator system 190, optional handheld device 110, optional checkpoint system 112, and second band receiver 502. In this exemplary embodiment, RFID tag 180 is configured to communicate with multiple tag interface devices in the form of remote interrogator system 190, handheld devices 110a and 110b, communication bridging device 402, local sensor/s 108, and checkpoint system 112 which are all operable to transmit and/or receive in a first band, e.g., NBFM reception and/or transmissions in an unlicensed 900 MHz frequency band (ranging from 902-907 MHz) or an unlicensed 915 MHz ISM band (ranging from 902-928 MHz) or unlicensed 433 MHz frequency band or any other unlicensed band, it being understood that other unlicensed or licensed frequency bands and non-NBFM frequencies may alternatively be employed for interrogator first band transmissions depending on the area of use and/or needs of the given application. Although an aRFID system and associated devices are described herein, it will be understood that embodiments of the disclosed systems and methods may also be implemented with passive RFID tags and semi-passive RFID tags, as well as RFID communication systems employing the same. In this regard, semi-passive RFID tag devices may remain in a sleep mode until receipt of a signal (e.g., interrogator polling signal) that wake up the device for transmission using internal battery powered transmitter onboard the semi-passive tag.

In one exemplary embodiment, aRFID tag 180 may be configured with the capability to receive NBFM transmissions in one of a plurality of channels of a multiple channel-based frequency band (e.g., one of at least 50 NBFM channels that are randomly distributed among other like aRFID tags 180 with a channel spacing of about 100 KHz). In such an embodiment, each aRFID tag 180 may be originally programmed with one of fifty 900 MHz channels that is selected as that tag's default frequency, so that the manufactured tags are evenly distributed among the 50 available channels. In this regard, 50 channels is the current minimum number of channels required to meet FCC restrictions for a frequency hopping system within the 900 MHZ ISM band (902-928 MHz). Other multiple channel-based frequency based bands may be similarly employed, e.g., with greater or fewer than 50 multiple channels. Example applications of aRFID tags 180 using such multiple channel-based frequency bands may be found further described in concurrently filed U.S. patent application Serial No. ______, entitled “DATA SEPARATION IN HIGH DENSITY ENVIRONMENTS” by Jonathan E. Brown et al., which is filed on the same date as the present application and which is incorporated herein by reference in its entirety.

Still referring to FIG. 1, each of remote interrogator system 190, handheld device 110, local sensor/s 108, and checkpoint system 112 include a first band transmitter or transceiver, or separate first band transmitter and/or first band receiver. It will be understood that any one or more of tag interface devices 110, 108 and 112 may be alternatively implemented to only have a first band transmit capacity (i.e., implemented only with a first band transmitter) so that all first band (e.g., NBFM) communications are unidirectional in the direction toward the aRFID tag 180. Further, remote interrogator 190 may be alternatively configured to also be capable of first band receive capability, e.g., for downloading stored sensor information and/or stored tag location history information from tag 180.

In this embodiment, remote interrogator system 190, handheld device 110, and checkpoint system 112 may be further characterized as tag interface control devices which are capable of exerting some control over one or more functions of a RFID tag 180 as described elsewhere herein. Second band receiver 502 operates in this exemplary embodiment to receive signals in a second band from aRFID tag 180, e.g., to receive UWB signals that are an antenna transmission in the range of 3.1 GHz up to 10.6 GHz at a limited transmit power of −41.3 dBm/MHz with an emitted signal bandwidth that exceeds the lesser of 500 MHz or 20% of the center frequency. However, it will be understood that other non-UWB communication signals (e.g., signals of other non-multiple channel-based frequency band) may be employed for second band communication in the practice of the disclosed systems and methods depending on the area of use and/or needs of the given application (e.g., 433 MHz or 915 MHz frequency bands or other suitable band). Moreover, it is also possible that more than two bands may be employed for transmission and/or reception by an RFID tag system 100.

Still referring to FIG. 1, aRFID tag 180 may also communicate over the first band NBFM link with one or more local sensors 108 which may be, for example, configured to collect and report data about an object that aRFID tag 180 is associated with and/or about the local environment. As so configured, aRFID communication system 100 may be implemented in one exemplary embodiment so as to allow aRFID tag 180 to capture sensor data and pass data points to a remote network via receiver 502 over the second band UWB link. Further information on such a remote network may be found described in concurrently filed U.S. patent application Ser. No. ______, entitled “DATA SEPARATION IN HIGH DENSITY ENVIRONMENTS” by Jonathan E. Brown et al., which is filed on the same date as the present application and which is incorporated herein by reference in its entirety.

Examples of environments where aRFID communication system 100 may be employed to track and/or obtain information regarding objects contained therein include, but are not limited to, a livestock feed lot, cultivated field, race track, hospital, warehouse, prison, city block, sports stadium, amusement park, airport, train station, shipyard, etc. Examples of objects that may be associated with individual aRFID tags 180 in such environments include, but are not limited to, individual livestock, farm equipment, race cars, hospital patients, warehouse articles/boxes, prisoners, vehicles, sports players or fans, amusement park patrons, baggage and/or passengers, ships or cargo therefore, etc., which may roam throughout the environment. Further information on tracking and monitoring information from aRFID tags in master coverage areas and aggregate coverage areas that include such environments may be found in concurrently filed U.S. patent application Ser. No. ______, entitled “DATA SEPARATION IN HIGH DENSITY ENVIRONMENTS” by Jonathan E. Brown et al., which is filed on the same date as the present application and which is incorporated herein by reference in its entirety.

Still referring to exemplary aRFID communication system 100 of FIG. 1, operation of aRFID tag 180 may be optionally changed in the field by any one or more of the tag interface control devices (e.g., remote interrogator system 190, handheld device 110, and/or checkpoint system 112) when aRFID tag 180 passes within NBFM transmission signal range of any of these tag interface devices. In this regard, any one or more of these tag interface control devices may send commands by NBFM signals to aRFID tag 180 that are operable to change one or more operations of aRFID tag 180 (e.g., data report rate, transmit power levels, tag sleep intervals, etc.). It is possible that a NBFM command signal may be broadcast to only change operation of an individual aRFID tag 180, or that a NBFM command signal may be broadcast instructing all aRFID tags 180 within range of the transmitting device to change their operation.

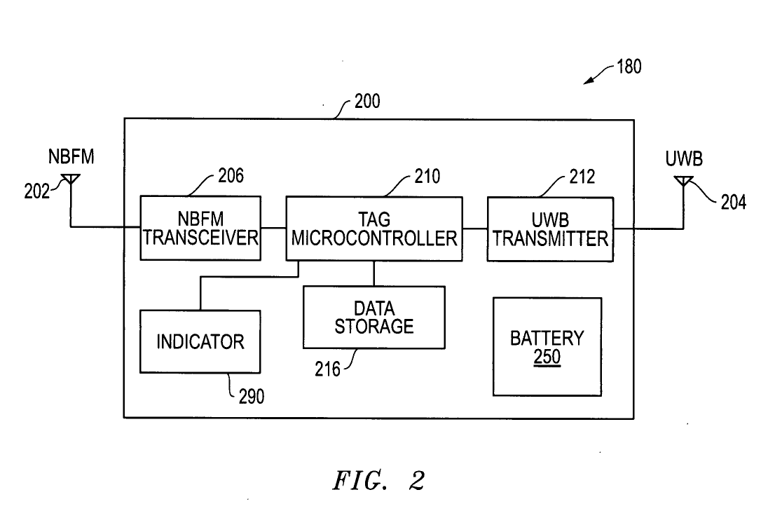

FIG. 2 illustrates one exemplary embodiment of circuitry 200 for a multi-band aRFID tag 180 such as may be employed in the aRFID communication system 100 of FIG. 1. As shown in FIG. 2, aRFID tag 180 includes an NBFM antenna element 202 for receiving NBFM interrogator polling signals from aRFIDI system 190 of FIG. 1, and may optionally receive NBFM data transmissions from one or more local or embedded sensors 108 (e.g., that report data about the object to which aRFID tag 180 is associated with or the local environment) or other equipment. NBFM antenna element 202 is coupled as shown to NBFM transceiver circuitry 206 that receives and transmits analog NBFM signals from NBFM antenna element 202 and exchanges digital NBFM signals with an onboard processing device of aRFID tag 180, in this case a tag microcontroller 210. It will be understood that an aRFID tag 180 may be provided with one or more such onboard processing devices (which may be microcontrollers, central processing units (CPU's), field programmable gate arrays (FPGAs), application specific integrated circuits (ASICs), combinations thereof, etc.) configured to perform tag processing functions such as described elsewhere herein.

Still referring to FIG. 2, NBFM transceiver circuitry 206 may also operate to optionally transmit command signals to one or more sensors 108, e.g., to change data rates or information content, etc. Such a command signal may be, for example, relayed by aRFID tag 180 from a tag interface device to a sensor 108 that is not in signal communication range of the sensor 108. Further, NBFM transceiver circuitry 206 may operate to relay collected sensor information to one or more tag interface devices. However, it will be understood that in one embodiment first band signal communication capability of aRFID tag 180 may be limited to reception only (e.g., an aRFID tag 180 may be provided with only an onboard first band receiver rather than a first band transceiver 206). A tag battery or battery pack 250 may also be provided for aRFID tag 180 as shown, to provide power for operation of other components of aRFID tag 180 including tag microcontroller 210, NBFM transceiver circuitry 206, tag external indicator 290 and UWB transmitter circuitry 212. In one exemplary embodiment, components of aRFID tag 180 may be hermetically sealed and isolated from the outside environment with no externally accessible electrical interconnections, i.e., such that the tag is only capable of wireless communication.

Still referring to FIG. 2, tag microcontroller 210 processes received NBFM interrogator polling signals (e.g., to determine if the received signal is of the correct data packet format corresponding to an interrogator polling signal transmitted by aRFIDI system 190), and in response thereto controls operation of UWB transmitter circuitry 212 to produce and transmit a UWB response signal via coupled UWB antenna element 204 that is formatted to include tag identification information that is unique to the given aRFID tag 180. A UWB response signal may also include status information about the tag, data points from optional local sensor circuitry device/s 108 that may be associated or in communication with the tag, other descriptive and/or identifying information about an object with which the aRFID tag 180 is associated, etc. Tag microcontroller 210 may also optionally preprocess received sensor data from local sensor/s 108 prior to relaying this data to UWB receiver 502 and/or a tag interface device, and/or may also optionally provide power control signals to each of NBFM transceiver circuitry 206 and UWB transmitter circuitry 212 (e.g., in order to conserve power consumed by these components of aRFID tag 180 in-between tag transmissions). It will be understood that an interrogator polling signal may also include other instructions, e.g., to cause aRFID tag 180 to record data from one or more external sensors, to cause aRFID tag 180 to transmit or otherwise exchange NBFM RF signals with other devices, to cause aRFID tag 180 to alter its timed sleep and listening cycles, etc.

As further shown in FIG. 2, tag microprocessor circuitry 210 may be coupled to onboard data storage circuitry 216 (e.g., non-volatile memory such as EEPROM, Flash memory, etc.), which may be provided for storage of records containing descriptive and/or identifying information about^{.} the object being tracked or monitored, e.g., tag location data points giving history of where the object/inventory has been, UWB and NBFM data packet format information, data from optional circuitry (e.g., such as sensor circuitry that monitors one or more parameters of the environment in which the aRFID tag 180 exists at a given time), object/inventory ownership or identification information, medical or vaccination records (e.g., where the object is a cow or other livestock), etc.

Data within onboard data storage circuitry 216 may be optionally changed or updated by one or more tag interface devices (e.g., remote interrogator system 190, handheld device 110, bridging device 402, local sensor/s 108, checkpoint system 112, or any other NBFM-transmission capable device). In one exemplary embodiment, the illustrated architecture of aRFID tag 180 may be employed to track a variety of different objects by providing a separate memory map within onboard data storage circuitry 216 of each aRFID tag 180 for each of two or more different types of objects with which the RFID tag 180 may potentially be associated. In this regard, the function of the separate memory map function may be present to provide a separate storage format with data fields appropriate to the given type of object which is currently associated with a given tag, while at the same time providing other separate storage format's with data fields appropriate to other types of object which may alternately be associated with the given tag (e.g., in the future). This ability to track different types of objects is further supported by the ability to dynamically change operation of an individual aRFID tag 180 on the fly within aRFID communication system 100, e.g., by allowing different data collection rates and/or sensor types which are appropriate for the object associated with a given tag.

Further shown in FIG. 2 is an optional tag external indicator 290 which may be provided onboard an aRFID tag 180. Tag external indicator 290 may be, for example, a visual indicator (e.g., light emitting diode, small strobe light, etc.), motion based indicator (e.g., vibrator), and/or an audio indicator (e.g., small speaker or beeper, etc.) that is powered by battery 250 and controlled by tag microcontroller 210. When present, such an optional tag external indicator 290 may be remotely activated by microcontroller 210 in response to an indicator request, for example, sent by first band NBFM signal transmissions to aRFID tag 180 from a tag interface device. When activated, external indicator 290 may be employed to produce an external indication (e.g., noise, light, motion such as vibrations, etc.) externally alert those persons in visual and/or audible range of indicator 290 of the current location of aRFID tag 180 and/or of a particular status of aRFID tag 180 or of an object with which it is associated.

Examples of suitable UWB transmitter circuitry and UWB methodology that may be employed for UWB transmissions between aRFID tag 180 and aRFIDI system 190 include, for example, transmitter circuitry described in concurrently filed U.S. patent application Ser. No. ______, entitled “SYSTEMS AND METHODS FOR GENERATING PULSED OUTPUT SIGNALS USING A GATED RF OSCILLATOR CIRCUIT” by Ross A. McClain Jr., et al., and signal transmission systems and methods described in concurrently filed U.S. patent application Ser. No. ______, entitled “PULSE LEVEL INTERLEAVING FOR UWB SYSTEMS,” by Bryan L. Westcott, et al., each of which is filed on the same date as the present application and each of which is incorporated herein by reference in its entirety. Further information on methodology that may be employed for communication using RFID tags 180 may be found in concurrently filed U.S. patent application Ser. No. ______, entitled “MOBILE COMMUNICATION DEVICE AND COMMUNICATION METHOD,” by Bryan L. Westcott et al., which is filed on the same date as the present application and which is incorporated herein by reference in its entirety.

Still referring to FIG. 2, tag microcontroller 210 may be configured in one exemplary embodiment to maintain synchronization with NBFM interrogator polling signals from aRFIDI system 190. For example, components of an aRFID tag 180 may be configured to perform the tag active operations (e.g., data processing, UWB response signal transmission, gathering data from sensors 108, etc.) after receiving a polling signal from aRFIDI system 190, and then to enter a timed low power sleep mode to reduce power consumption in-between interrogator polling signals from system 190. Tag microcontroller 210 may be programmed with a sleep timer that wakes up the components of aRFID tag 180 before the next polling packet of an NBFM interrogator polling signal arrives from aRFIDI system 190. Due to relatively high power consumption rate of NBFM transceiver 206, the closer in time that the components of aRFID tag 180 (including NBFM transceiver 206) awake before receipt of the next polling packet, the more power that may be conserved to increase tag battery life. Such a configuration allows aRFID tag 180 to operate with a very small receive buffer time while staying synchronized with aRFIDI system 190. Further information on such an adaptive wakeup scheme or methodology that may be implemented in one exemplary embodiment to allow an aRFID tag to stay synchronized with an aRFIDI system while at the same time optimizing power consumption may be found in concurrently filed U.S. patent application Ser. No. ______, entitled “DATA SEPARATION IN HIGH DENSITY ENVIRONMENTS” by Jonathan E. Brown et al., which is filed on the same date as the present application and which is incorporated herein by reference in its entirety.

Returning to the exemplary embodiment of FIG. 1, aRFID tag 180 is capable as shown of receiving NBFM transmissions from each of multiple tag interface devices (e.g., remote interrogator system 190, handheld devices 110a and 110b (e.g., through an optional communication bridging device 402), local sensor/s 108, checkpoint system 112). Such NBFM transmissions may be used (automatically, on a time schedule, and/or in response to a user command) to change data in tag onboard data storage 216. A local sensor 108 may be any device capable of collecting information about the external and/or internal conditions of an object or environment to which it is exposed, and will be described further herein.

Still referring to FIG. 1, each of tag interface control devices (e.g., remote interrogator system 190, handheld device 110, and/or checkpoint system 112) are each configured to transmit NBFM control signals to aRFID tag 180 for purposes of altering one or more operations or tasks of aRFID tag 180 as previously mentioned. In particular, control signals may be transmitted by a given tag interface control device to aRFID tag 180 to change one or more configuration parameters that are stored in onboard storage 216 of aRFID tag 180 and used by tag microcontroller 210 to alter operations of aRFID tag 180. Examples of tag operations that may be controlled by such configuration parameters include, but are not limited to, tag data report rate over UWB, tag UWB and/or NBFM transmit power levels, tag sleep intervals between UWB transmissions, etc. Further information on implementations of a remote interrogator system 190 may be found in concurrently filed U.S. patent application Ser. No. ______, entitled “DATA SEPARATION IN HIGH DENSITY ENVIRONMENTS” by Jonathan E. Brown et al., which is filed on the same date as the present application and which is incorporated herein by reference in its entirety.

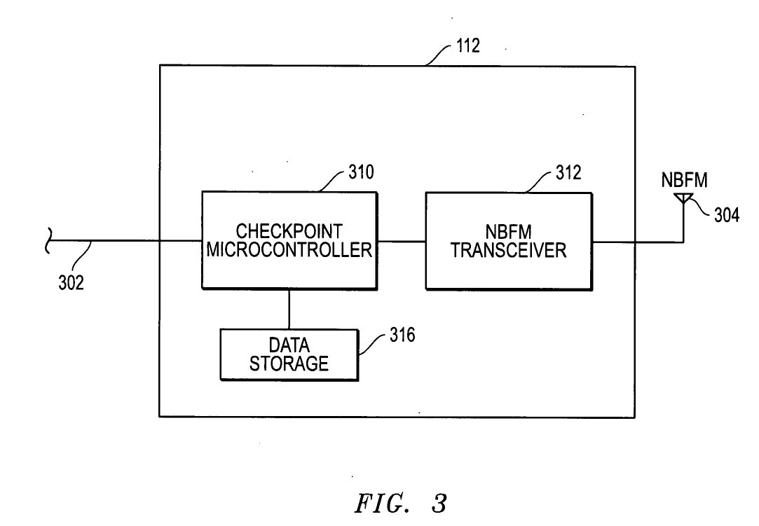

FIG. 3 illustrates one exemplary embodiment of a checkpoint interface control device circuitry 112 that may be optionally provided in an aRFID communication system 100 such as illustrated in FIG. 1. As shown in FIG. 3, checkpoint device circuitry 112 includes NBFM transceiver circuitry 312 that is coupled to communicate with one or more aRFID tags 180 via analog NBFM signals received and transmitted from NBFM antenna element 304. NBFM transceiver circuitry 312 is in turn coupled to exchange digital NBFM signals with checkpoint microcontroller 310, which controls operation of checkpoint device circuitry 112. Optional data storage 316 may also be provided as shown, e.g., for storing any downloaded data received from aRFID tags 180 and/or for storing identity of individual aRFID tags 180 that have communicated with checkpoint device circuitry 112, time and date that each aRFID tag 180 communicated with checkpoint device circuitry 112, etc. An optional external data communication link 302 may be provided, e.g., for connection to an external network (e.g., LAN, WLAN, Internet, corporate or governmental intranet, etc.). Such an optional external data communication link 302 may be used, for example, to transfer downloaded data from aRFID tags 180 to the external network or to report other tag-related information such as identity of individual aRFID tags 180 that have communicated with checkpoint device circuitry 112, time and date that each aRFID tag 180 communicated with checkpoint device circuitry 112, etc. Such an optional external data communication link 302 may also be used to provide external commands or programming to checkpoint device circuitry 112.

In operation, checkpoint interface control device 112 may be positioned, for example, at a fixed location within a master coverage area 194 of an aRFID system such as described and illustrated in concurrently filed U.S. patent application Ser. No. ______, entitled “DATA SEPARATION IN HIGH DENSITY ENVIRONMENTS” by Jonathan E. Brown et al., which is filed on the same date as the present application and which is incorporated herein by reference in its entirety. In such an application, a checkpoint device 112 may transmit NBFM communications to a given mobile or roaming aRFID tag 180 only when the tag 180 passes within a predefined proximity to the checkpoint device 112 (e.g., within a limited range that is shorter than the allowed roaming distance of the aRFID tag 180 in its deployed RFID tracking environment, and/or that is shorter than the distance to the nearest aRFIDI system 190). Such a proximity-based NBFM transmission from checkpoint device 112 may be implemented within this predefined proximity, for example, by virtue of the checkpoint device 112 sending a first band NBFM broadcast message of defined transmission range out to all tags 180 that come within a given predefined range of the checkpoint device 112. In other cases, a motion detector or other proximity sensor may be employed to trigger a short duration first band NBFM message transmission from the checkpoint device 112 upon detection of a passing object.

These NBFM transmissions from checkpoint device 112 to aRFID tag 180 may be used, for example, to change one or more operations of aRFID tag 180 (e.g., tag data report rate, UWB and or NBFM transmit power levels, methodology of interaction of the tag with local sensors, tag sleep intervals, etc.). Thus, for example, when an object that is associated with a given aRFID tag 180 moves into a given area monitored by a given aRFID system 100, UWB signal transmission rates from the given aRFID tag 180 may be modified, e.g., to an increased frequency.

Thus, in an exemplary cattle sale lot embodiment, frequency of UWB signal transmission intervals may be increased (e.g., from one transmission every eight seconds to one transmission every second) when a particular cow moves from a pre-stage holding area to a televised exhibition area in which potential buyers in the local audience or televised audience need rapid updates to sensed information about the cow and/or its location. Such a change in UWB signal transmission frequency may be effected by placing a first checkpoint device 112 at a point adjacent the entrance (e.g., entrance gate) to the exhibition area so that NBFM command transmissions from the first checkpoint device 112 will be received by any aRFID tag 180 as it passes with its associated cow into the exhibition area to instruct the aRFID tag 180 to increase its UWB signal transmission frequency. A second checkpoint device may be placed at a point adjacent the exit (e.g., exit gate) of the exhibition area so that NBFM command transmissions from the second checkpoint device 112 will be received by any aRFID tag 180 as it passes with its associated cow out of the exhibition area to instruct the aRFID tag 180 to decrease its UWB signal transmission frequency. A similar checkpoint device deployment configuration may be implemented for any tag tracking application where more frequent UWB signal transmissions are desired from an aRFID tag 180 in a given area relative to another given area.

In another example, a checkpoint device 112 positioned near the exit of a given RFID-monitored area or master coverage area may instruct aRFID tags 180 leaving the given monitored area through the exit to cease all UWB signal transmissions. Such an implementation may be desirable, for example, where no RFID tracking is employed outside the given RFID-monitored area and it is desired to conserver power consumption by the tag outside the area. Conversely, a checkpoint device 112 may also be positioned near the entrance a given RFID-monitored area or master coverage area to instruct aRFID tags 180 entering the given monitored area through the entrance to initiate all UWB signal transmissions, e.g., when aRFID tags 180 enter the monitored area in a no UWB transmission state. Alternatively, a single checkpoint device 112 may be positioned at a single access point to a given RFID-monitored area to query the identity of aRFID tags 180 as they pass into or out of the given area, and based on stored information regarding the previous location of each aRFID tag 180 in data storage 316 (e.g., either inside or outside the given monitored area), instruct each aRFID tag 180 to modify its behavior based on whether it is entering or exiting the given monitored area.

It will be understood that a given checkpoint device 112 may operate in similar manner to modify other tag operations (e.g., such as UWB and/or NBFM transmit power levels, methodology of interaction of the tag with local sensors, tag sleep intervals, etc.) when a given aRFID tag 180 passes into or out of a given monitored area. For example, UWB and/or NBFM tag transmit levels may be modified to be higher when an aRFID tag 180 is moving into a larger RFID-monitored area, i.e., where interrogator system/s are spaced farther away and higher-powered UWB transmissions are therefore required.

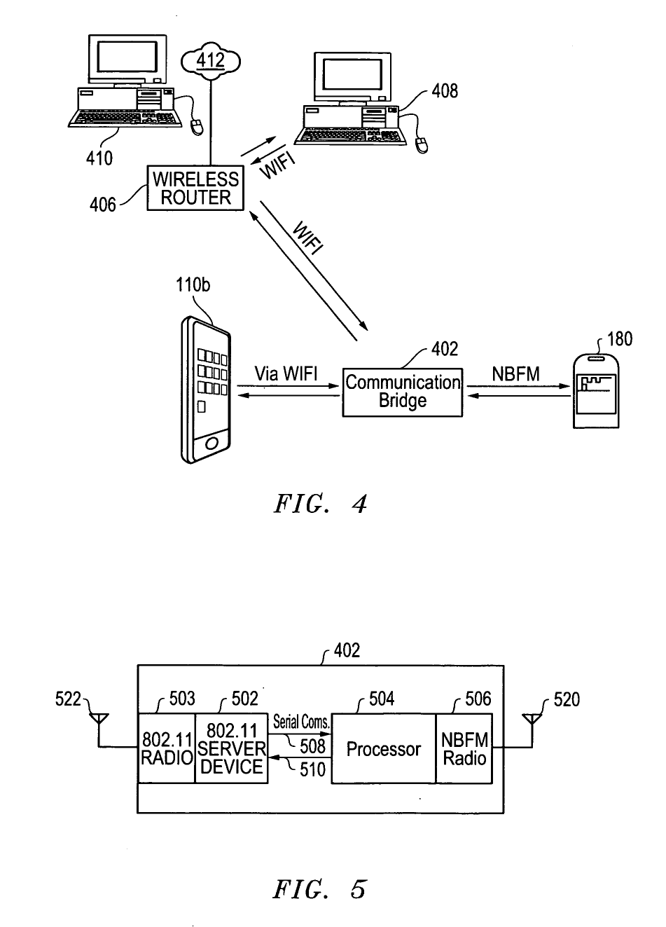

FIG. 4 illustrates an exemplary embodiment in which a third band capable device 110b (in this case a handheld WiFi-capable smart phone such as an Apple iPhone) may be employed as a tag interface control device when communicating with aRFID tag 180 through bidirectional communication bridging device 402, e.g., to retrieve or change stored data and/or change the tag operation (e.g., change programming of the tag). In the illustrated embodiment, third band capable device 110b is battery powered and portable in nature, capable of fitting on a person's belt or in a person's pants or shirt pocket. However, a communication bridging device 402 may be employed in other embodiments to bridge data communications between the first band of aRFID tag 180 and other types of third band-capable devices 110b, e.g., notebook computers, WLAN routers or any other type of WiFi enabled devices having a wireless network card or capability.

As shown in FIG. 4, handheld device 110b bidirectionally communicates data with bridging device 402 via third band WiFi 802.11x wireless communications, and bridging device 402 in turn communicates the same data with aRFID tag 180 using first band NBFM wireless communications. In this regard, bridging device 402 is configured in this embodiment to convert WiFi signals transmitted from third band capable device 110b in real time to NBFM signals transmitted to aRFID tag 180, and to convert NBFM signals transmitted from aRFID tag 180 in real time to WiFi signals transmitted to third band capable device 110b in a manner that provides bidirectional data communication between third band capable device 110b and one or more aRFID tags 180. As previously mentioned, a communication bridging device such as communication bridging device 402 may be alternatively implemented to convert third band signals other than WiFi signals to first band signals other than NBFM signals and vice-versa.

As further shown in FIG. 4, communication bridging device 402 may be implemented to communicate via its WiFi with a wireless network router 406 which in turn communicates by wired or wireless connection to other network devices (e.g., computers) on a wireless local area network (WLAN), corporate or governmental intranet network, or the Internet, e.g., such that any computer on a network communicating with router 406 may communicate with aRFID tag 180. For example, in the illustrated embodiment of FIG. 4, communication bridging device 402 is shown communicating with computer 408 via WiFi connection from router 406, with computer 410 via wired (e.g., Ethernet) connection from router 406, and with a variety of other computing devices over the Internet via router 406. work with a router so that any computer on a network could communicate with the tags. It will be understood that in other embodiments, aRFID tag 180 may be replaced for communication though bridging device 402 with any other type of device that uses NBFM signals as its means of data transfer, e.g., NBFM equipped sensors.

FIG. 5 illustrates communication bridging device 402 as it may be configured according to one exemplary embodiment of the disclosed systems and methods. As shown in FIG. 5, communication bridging device 402 includes WiFi antenna 522 coupled to 802.11 transceiver radio circuitry 503 and socket server device circuitry 502, which is in turn coupled via serial connection to a NBFM-side processor 504, embedded NBFM transceiver radio circuitry 506, and NBFM antenna 520. In the illustrated configuration, 802.11 signal transmissions are received by WiFi antenna 522 and provided to 802.11 transceiver radio circuitry 503, which in turn provides received 802.11 packets to embedded socket server device circuitry 502. Socket server device circuitry 502 converts all incoming 802.11 packets into serial data 508 which is provided to NBFM-side processor 504 as shown. Socket server device circuitry 502 also converts incoming serial data 510 from NBFM-side processor 504 into outgoing 802.11 packets using start and stop bytes. In one exemplary embodiment, 802.11 transceiver radio circuitry 503 may be provided with embedded socket server device circuitry 502 as a network server module such as Lantronix Matchport b/g serial to WiFi adapter available from Lantronix, Inc. of Irvine, Calif. However, it will be understood that any other configuration of integrated or separate 802.11 transceiver and server device circuitry may be employed. Further, in addition to the illustrated components of FIG. 5, it will be understood by those of skill in the art that other supporting circuitry may be present, e.g., such as power supply and RF filters.

Still referring to FIG. 5, NBFM-side processor 504 of communication bridging device 402 receives incoming serial data 508 from 802.11 socket server device circuitry 502 via the serial connection, creates its own NBFM packet with the data, and then transmits the data to an aRFID tag 180 through NBFM transceiver radio 506. NBFM-side processor 504 may be any processing device (e.g., microprocessor, microcontroller, ASIC, FPGA, etc.) suitable for converting 802.11 packets to NBFM data format suitable for transmission by a NBFM transceiver radio via NBFM antenna 520. In one exemplary embodiment, NBFM-side processor 504 and NBFM transceiver radio 506 may be implemented together as a Chipcon CC1110 low-power sub-1 GHz RF System-on-Chip having microcontroller (MCU), memory, embedded NBFM transceiver, and USB controller (Chipcon products now available from Texas Instruments of Dallas, Tex.). Communications from an aRFID tag 180 are received at NBFM antenna 520 by NBFM transceiver radio 506, processed by NBFM-side processor 504, and sent to 802.11 network server chip 502 as serial data 510 as shown. Socket server device circuitry 502 converts incoming serial data 510 from NBFM-side processor 504 into outgoing 802.11 packets for retransmission to 802.11 capable device/s 110 such as a handheld device or other type of third band capable device 110.

In the exemplary embodiment of FIG. 5, components of communication bridging device 402 (802.11 transceiver radio circuitry 503, socket server device circuitry 502, NBFM-side processor 504, and embedded NBFM transceiver radio circuitry 506) may be provided as a single device having its own battery power supply, e.g., battery pack. No physical connection or attachment between the communication bridging device 402 and either of aRFID tag 180 or third band-capable device 110 is required. To perform its third band-to-first band bridging function (e.g., 802.11x to NBFM), communication bridging device 402 need only be positioned simultaneously within third band signal communication range of third band-capable device 110 and within first band signal communication range of aRFID tag 180.

As previously described, an aRFID tag 180 may be configured in certain embodiments to enter a timed and synchronized low power sleep mode to reduce power consumption in-between interrogator polling signals transmitted from an interrogator system 190. In another embodiment, an aRFID tag 180 may be configured to remain in a low power sleep mode at all times except when activated by receipt of external first band signals. In such embodiments, a communication bridging device 402 (or other tag interface device) may be configured to employ one or more techniques for initiating communications with an aRFID tag 180 of the type that is configured to listen for first band transmissions only for short periods of time.

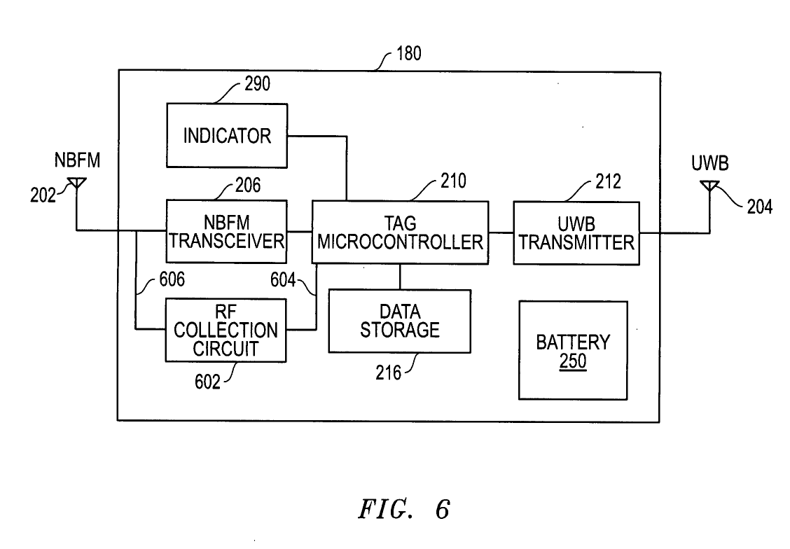

In a first one of such embodiments, an aRFID tag 180 may be provided with an optional RF collection circuit 602 as shown in FIG. 6. Such an RF collection circuit 602 is operable to sense the presence of a first band signal by converting a received NBFM or other first band signal into a voltage that may be used to create an interrupt signal 604 that is then supplied to tag microcontroller 210. Suitable circuitry for RF collection circuit 602 includes, for example, a Schottky diode based energy detector. In such an embodiment, RF collection circuit 602 is open for receiving NBFM signal transmissions via NBFM antenna 202 even when a RFID tag 180 is in sleep mode and NBFM transceiver 206 is in a power off condition. When RF collection circuit 602 receives a NBFM transmission 606 from communication bridging device 402 that is of sufficient strength to activate RF collection circuit 602, RF collection circuit 602 produces an interrupt signal to tag microcontroller 602 that causes tag microcontroller 602 activate aRFID tag 180 from sleep mode so that NBFM transceiver 206 listens for NBFM transmissions from communication bridging device 402. Thus, an aRFID tag 180 may be instantaneously awakened from sleep mode in an on-the-fly manner when communication bridging device 402 begins transmitting, so that it is ready to receive NBFM data communications from communication bridging device 402. This allows communication with a sleeping aRFID tag 180 to be established in an ad hoc manner and in-between tag awake cycles (i.e., during a tag sleep cycle). It will be understood that any other type of tag interface device (e.g., interrogator system, checkpoint, sensor, etc.) may employ a similar methodology for initiating communications with an aRFID tag 180.

In another exemplary embodiment, a communication bridging device 402 (or other type of tag interface device) may be configured to specifically initiate communication with an aRFID tag 180 of the type that operates the majority of the time in a low power sleep mode and only wakes to periodically for short periods of time to listen for interrogator system polling signals (e.g., to listen for 2 milliseconds once every 8 seconds). Such a periodic-waking tag implementation may be employed, for example, to avoid packet collisions in RFID system environments where there are many aRFID tags 180 coexisting in the same RFID system coverage area by programming the tags such that they wake up to listen for NBFM communications in random order and at different times from each other. In such an embodiment, a communication bridging device 402 or other type of tag interface device may be configured to transmit a NBFM signal with a “wake-up” message that instructs any listening aRFID tags 180 to stay active for a longer period of time to allow the tag interface device to initiate further NBFM communications with a specific aRFID tag 180.

The NBFM signal with wake up message may be transmitted continuously for at least the maximum duration of the sleep time of aRFID tag 180. For example, if the aRFID tag 180 is configured to wake up every 8 seconds to listen and then go back to sleep, then the communication bridging device 402 or other type of tag interface device must broadcast its NBFM “wake-up” message continuously for a minimum of 8 seconds to ensure that the aRFID tag 180 receives the wake-up message. In some embodiments, an aRFID tag 180 may be configured so that once it has activated itself it will reenter its sleep mode after the duration of a specific listening time (e.g., after 2 milliseconds in this example). In such cases, the communication bridging device 402 or other type of tag interface device may be configured to transmit its wake-up message within a time period less than or equal to the specific aRFID tag listening time (e.g., within a time period of less than or equal to 2 milliseconds in this example), and to rebroadcast this wakeup message continuously during the duration of the transmitted NBFM signal (e.g., 8 seconds in this example).

Any listening aRFID tags 180 that receive the wake up message will then wake at an increased rate for a given amount of time (e.g., the tag 180 will wake and listen for 2 milliseconds once every 1 second interval for a period of 10 minutes before defaulting back to its once every 8 second wake up period interval). This decreased sleep period is to allow for quicker responses to serial select messages from communication bridging device 402. The communication bridging device 402 may then send a second message which selects a particular aRFID tag 180 based on its serial number. To ensure receipt by the selected aRFID tag 180 this serial select message may be sent continuously for up to the length of the duration of the tag's new wake up period interval (e.g., sent continuously for up to 1 second in the given example). When the particular selected aRFID tag 180 receives this serial select message, it acknowledges receipt to the bridge device 402 and enters a communications state with the bridge device 402. In this state, the selected aRFID tag 180 remains awake until communications are terminated by the bridge device 402 or the loss of a connection between the selected aRFID tag 180 and bridge device 402 is detected. The bridge device 402 may then select another aRFID tag 180 for communication and repeat this process.

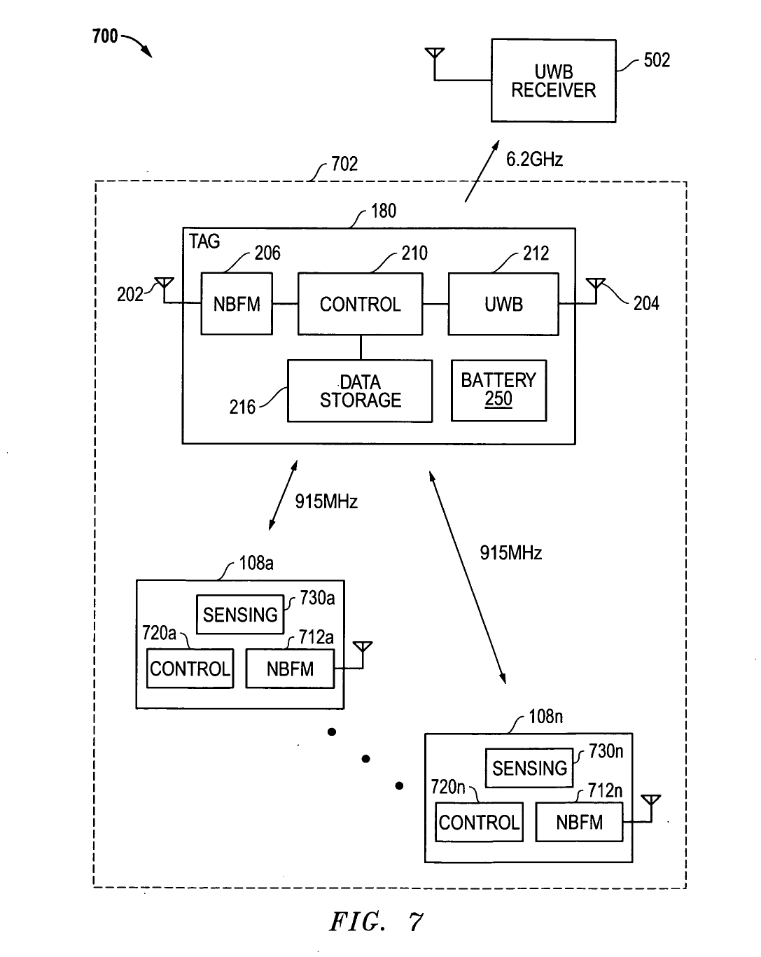

FIG. 7 illustrates components of an aRFID communication system 700 that in this exemplary embodiment include multiple local sensors 108a-108n, a multi-band aRFID tag 180, and a UWB receiver 501. In this exemplary embodiment, multi-band aRFID tag 180 is equipped with a NBFM transceiver 212 and a UWB transmitter 206 (such as described and illustrated in relation to FIG. 2). In the embodiment of FIG. 7, aRFID tag 180 is implemented to work as a bridge between each of NBFM-capable multiple local sensors 108a-108n and a UWB remote receiver 502. In this exemplary embodiment, each of local sensors 108a-108n is associated with (e.g., attached to or contained inside) a respective corresponding object 702a-702n, which may be any object that is suitable for tracking or monitoring, e.g., livestock, farm equipment, race cars, trucks, rental cars and other vehicles, hospital patients, warehouse articles or boxes, library books, legal documents, tools, machines, guns or other weapons and accessories therefor, prisoners, sports players or fans, amusement park patrons, baggage and/or passengers, ships or cargo, etc. In one exemplary embodiment, multiple local sensors 108a-108n may be configured as a sensor array.

In the illustrated embodiment of FIG. 7, local sensor 108 may be attached or otherwise associated with the same object to which aRFID tag 180 is associated, in which case local sensor 108 is always in NBFM communication range of aRFID tag 180 and is therefore capable of transmitting sensor information to aRFID tag 180 at any given time or time interval. It will be understood however, that a given sensor 108 may alternatively be freestanding in the environment, i.e., not attached to or otherwise associated with a particular object. Notwithstanding the multiple local sensors 108a-108n shown associated with object 702 in FIG. 7, it will be understood that a single sensor 108 may also be associated with an object 702 and aRFID tag 180 in a similar manner.

Each of local sensors 108a-108n of FIG. 7 may be any device capable of collecting information (e.g., using one or more corresponding sensing elements 730) about certain external and/or internal conditions of an object 702 with which sensors 108a-108n are associated, and of transmitting this information from its NBFM transmitter 712 as NBFM signals to NBFM transceiver 206 of aRFID tag 108 that is also associated with object 702, e.g., for storage in tag on-board data storage 216. For example, a sensing element 730 of a given local sensor 108 that is externally attached to object 702 may be configured to sense one or more weather-related parameters (e.g., temperature, barometric pressure, wind speed, humidity, rainfall, etc.) of the environment to which object 702 is exposed. Other examples of sensing elements 730 include, but are not limited to, motion or directional sensing elements (e.g., such as accelerometers, speedometers, compasses, altimeters, etc.) that continuously or periodically report motion or positional related information (e.g., GPS-derived location data) about object 730 to which the individual sensor is attached. As shown, each local sensor 108a-108n also may contain a corresponding microcontroller or other processing device 720 for interfacing with sensing element 730 and controlling transmission of sensed information using NBFM transmitter 712.

Still referring to FIG. 7, each of sensors 108a-108n may be configured to monitor and report one or more internal conditions of object 702. For example, a given sensor 108 may be configured as a bolus or other type of insertable sensor that is internally positioned at a location within the body (e.g., in the stomach or intestines) of a cow or other type of livestock 702, and may include sensing element/s 730 for monitoring livestock body temperature, detecting presence of a virus, monitoring blood properties, PH levels, etc. In such an example, the monitored information is transmitted by NBFM signals to a corresponding aRFID tag 180 that is externally attached to the same livestock individual 702 (e.g., to an ear of a cow). Additionally, it is possible that multiple such sensors 108 may be placed in different locations of the body of the same livestock individual 702.

In another example, a given sensor 108 may be configured for insertion into a box or other item of inventory 702 that is also associated with a corresponding aRFID tag 180, which may be externally attached to, or internally enclosed within, the same inventory item 702. In such an example, the given sensor 108 may be present alone or with other sensors 108 to monitor the conditions to which the inventory item 702 (or its contents) is exposed. In this regard, each such sensor 108 may include sensing element/s 730 for monitoring and transmitting by NBFM signals to aRFID tag 180 information regarding one or more sensed parameters such as temperature, humidity, vibrational shock, orientational position, etc. Monitoring of such parameters may be desirable where a inventory item 702 includes sensitive contents, such as expensive wines, animals, sensitive electronics, etc.

Whatever the particular application, an individual aRFID tag 180 may receive and store information in tag data storage 216 that has been transmitted by NBFM signal communication from one or more sensors 108, e.g., for later re-transmission by UWB signals from aRFID tag 180 to a UWB remote receiver 502, and/or for later re-transmission by NBFM signals from aRFID tag 180 to a tag interface device such as checkpoint device 112, handheld device 110 (e.g., through a communication bridging device 402) or interrogator device 190. As previously mentioned, a UWB remote receiver 502 may then pass the collected sensor data to a remote network for further processing, storage and/or user access. Additionally or alternatively, aRFID tag 180 may optionally preprocess the collected data (e.g., using tag microcontroller 210) before relaying the pre-processed information to a remote receiver 502 or tag interface device by UWB and/or NBFM signal communication. Examples of such data pre-processing include, but are not limited to, sorting collected data, data averaging, setting alerts for data values outside a given range, recording of maximum and/or minimum data values, selecting particular data for transmission based on data value or other characteristic, organizing data into categories, etc.

It is also possible that aRFID tag 180 may send command signals by first band (e.g., NBFM) signal communications to one or more sensors 108 to alter sensor operation, e.g., such as altering types of sensor data collected, altering method or frequency of sensor data collection, altering sensor data rates or information content transmitted to aRFID tag 180 from sensor 108, etc. Such a command signal may be originated by a processing device on board the aRFID 180, or may be received from a tag interface device and stored in onboard data storage of aRFID tag 180, for relay and later retransmission to one or more sensors 108 that are out of first band signal communication range with the tag interface device.

Optional storage of collected sensor information in data storage 216 of aRFID tag 180 may be useful, for example, where an object 702 resides (e.g., is stored or transported) for a period of time during which no access exists for transmission of sensor data to a UWB receiver (e.g., goods or livestock shipped from one location to another, goods stored in a warehouse, livestock allowed to graze in an uncontrolled area, etc.). Upon arrival at a location in signal communication proximity to an active aRFIDI system 190 and UWB receiver 502, the aRFID tag 180 may receive a NBFM interrogator polling signal from the aRFIDI system 190 and transmit a UWB response signal in response thereto. The UWB response signal may include stored historical sensor information that has been collected by aRFID tag 180 from associated sensors 108 during the period of time that no access was available for transmitting sensor information. The transmitted historical sensor information may then be reviewed to determine, for example, what conditions an object 702 has been exposed to during transit or storage. Where a tagged object is livestock or other animal, the transmitted historical sensor information may also or alternatively include monitored health information (e.g., body temperature, vital signs, etc.) that may be reviewed to determine the health history of the animal during transit, storage, grazing, etc.

Although FIG. 7 shows local sensors 108a-108n and corresponding aRFID tag 180 associated with (e.g., attached to or contained within) the same object 702, it will be understood that in another embodiment one or more local sensors 108 may be associated with an object that is not associated with an aRFID tag 180 and/or may not be associated with any particular object (e.g., may be freestanding sensors). In such an alternative embodiment, no sensor information will be transferred from such a sensor 108 until a given aRFID tag 180 moves to within NBFM signal proximity to local sensor 108 so that sensor information may be transmitted from sensor 108 to an aRFID relay tag 180. The given aRFID relay tag 180 may then store and relay the collected sensor information for downloading to a UWB receiver 502 or tag interface device at another location.

In one example implementation of the preceding tag relay embodiment, a sensor 108 may be deployed in a location that is out of signal communication range with any aRFIDI system 190 and UWB receiver 502. Such a location may be, for example, a remote area of a cattle ranch, and such a sensor 108 may be configured with a sensor element that measures, for example, environmental conditions such as rainfall or water trough level. One or more multiband aRFID relay tags 180 may be associated with livestock animals that roam the ranch between the remote area of the ranch and another area of the ranch that is within signal communication range of an aRFIDI system 190 and

UWB receiver 502. Sensor information from the remotely-located sensor may be downloaded and stored by a given aRFID relay tag 180 when its associated livestock animal passes within NBFM signal communication proximity to the remotely-located sensor 108. The aRFID relay tag 180 may then relay and transmit the stored sensor information to the UWB receiver 502 when the livestock animal returns to within signal communication range of aRFIDI system 190 and UWB receiver 502.

In another tag relay embodiment example, one or more sensors 108 may be associated with a first animal (wild animal or livestock) by attachment or insertion, and the first animal released, e.g., to the wild. An aRFID relay tag 180 may be associated with a second animal that is also released to freely associate with the first animal, but that is also trained to return to within signal communication range of an aRFIDI system 190 and a UWB receiver 502. Each time the second animal associates with (i.e., comes in close proximity to) the first animal, the aRFID relay tag 180 collects sensor information from sensor 108 that is associated with the first animal and stores this information in its data storage 216. The stored sensor information is then relayed and transmitted from the aRFID relay tag 180 to the UWB receiver 502 when the second animal returns to within signal communication range of the aRFIDI system 190 and UWB receiver 502. The second animal may be released and returned over and over in this manner to monitor health, location, or other aspects of the first animal over time.

It will be understood that one or more of the tasks, functions, or methodologies described herein may be implemented, for example, as firmware or other computer program of instructions embodied in a tangible computer readable medium that is executed by a CPU, microcontroller, or other suitable processing device.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

What is claimed is:

1. A method of relaying information using a radio frequency identification (RFID) relay tag system, comprising:
receiving first band RF signal communications at an RFID relay tag from at least one sensor, the received first band RF signal communications containing sensor data produced by the sensor;
processing the received first band RF signal communications on the RFID relay tag to obtain the sensor data; and
transmitting the obtained sensor data from the RFID relay tag in at least one of a first band RF signal communication, a second band RF signal communication, or a combination thereof;
wherein the first band is a multiple channel-based frequency band;
wherein the second band is a non-channel based frequency band; and
wherein the RFID relay tag is associated with an object.

2. The method of claim 1, wherein the first band is a narrow band frequency modulation (NBFM) frequency band; and wherein the second band is an ultra-wideband (UWB) frequency band.

3. The method of claim 1, further comprising storing the obtained sensor data in data storage circuitry on board the RFID relay tag prior to transmitting the sensor data from the RFID relay tag in at least one of a first band RF signal communication, a second band RF signal communication, or a combination thereof.

4. The method of claim 1, further comprising preprocessing the obtained sensor data prior to transmitting the preprocessed sensor data from the RFID relay tag in at least one of a first band RF signal communication, a second band RF signal communication, or a combination thereof.

5. The method of claim 1, further comprising transmitting the obtained sensor data from the RFID relay tag by a first band RF signal communication.

6. The method of claim 1, further comprising transmitting the obtained sensor data from the RFID relay tag by a second band RF signal communication.

7. The method of claim 6, wherein the first band RF signal communication has a communication range that is shorter than the communication range of the second band RF signal communication.

8. The method of claim 7, further comprising:
receiving the first band RF signal communications containing the produced sensor data at the RFID relay tag from at least one local sensor, the at least one local sensor being positioned at a first geographic location that is within first band signal communication range of the RFID relay tag and its associated object but that is not within first band signal communication range of a remote receiver that is positioned at a second geographic location; and
transmitting the obtained sensor data from the RFID relay tag to the remote receiver in a second band RF signal communication, the second geographic location of the remote receiver being within second band signal communication range of the RFID relay tag and its associated object.

9. The method of claim 7, further comprising:
receiving the first band RF signal communications containing the produced sensor data at the RFID relay tag from at least one local sensor positioned at a first geographic location, the RFID relay tag and its associated object being positioned at a second geographic location when receiving the first band RF signal communications containing the produced sensor data, wherein neither of the first or second geographic locations is within second band signal communication range of a remote receiver that is positioned at a third geographic location;
storing the obtained sensor data in data storage circuitry on board the RFID relay tag;
retrieving the stored data from the data storage circuitry on board the RFID relay tag; and
transmitting the sensor data in a second band RF signal communication from the RFID relay tag to the remote receiver positioned at the third geographic location, the third geographic location of the remote receiver being within second band signal communication range of a fourth location of the RFID relay tag and its associated object while the RFID relay tag is transmitting.

10. The method of claim 7, further comprising:
receiving the first band RF signal communications containing the produced sensor data at the RFID relay tag from at least one local sensor positioned at a first geographic location, the RFID relay tag being positioned at a second geographic location with its associated object when receiving the first band RF signal communications containing the produced sensor data, wherein neither of the first or second geographic locations is within first band signal communication range of a tag interface device that is positioned at a third geographic location;
storing the obtained sensor data in data storage circuitry on board the RFID relay tag;
retrieving the stored data from the data storage circuitry on board the RFID relay tag; and
transmitting the retrieved sensor data in a first band RF signal communication from the RFID relay tag to the tag interface device positioned at the third geographic location, the third geographic location of the tag interface device being within first band signal communication range of a fourth geographic location of the RFID relay tag and its associated object while the RFID relay tag is transmitting.

11. A method of controlling sensor operation, comprising transmitting a command signal from a RFID relay tag that is associated with an object to at least one sensor by a first band RF signal communication, the command signal being effective to alter operation of the at least one sensor receiving the command signal from the RFID relay tag; wherein the first band is a multiple channel-based frequency band.

12. The method of claim 11, further comprising:
receiving the command signal in a first band RF signal communication received at the RFID relay tag from a tag interface device positioned at a first geographic location while the RFID relay tag and its associated object are positioned at a second geographic location, wherein neither of the first or second geographic locations is within first band signal communication range of at least one sensor device that is positioned at a third geographic location;
storing the received command signal in data storage circuitry on board the RFID relay tag;
retrieving the stored command signal from the data storage circuitry on board the RFID relay tag; and
transmitting first band RF signal communications containing the retrieved command signal from the RFID relay tag to the at least one local sensor positioned at a third geographic location, the RFID relay tag being positioned at a fourth geographic location with its associated object when transmitting the first band RF signal communications containing the command signal, the fourth geographic location being within first band signal communication range of the third geographic location.

13. A RFID communication system, comprising:
at least one sensor configured to produce sensor data and to transmit the produced sensor data within first band RF signal communications;
a radio frequency identification (RFID) relay tag configured to receive the first band RF signal communications containing the produced sensor data from the at least one sensor, process the received first band RF signal communications on the RFID relay tag to obtain the produced sensor data, and transmit the obtained sensor data from the RFID relay tag in at least one of a first band RF signal communication, a second band RF signal communication, or a combination thereof;
wherein the first band is a multiple channel-based frequency band;
wherein the second band is a non-channel based frequency band; and
wherein the RFID relay tag is configured to remain associated with an object as the object moves from one geographic location to another geographic location.

14. The system of claim 13, wherein the first band is a narrow band frequency modulation (NBFM) frequency band; and wherein the second band is an ultra-wideband (UWB) frequency band.

15. The system of claim 13, wherein the RFID relay tag is further configured to store the obtained sensor data in data storage circuitry on board the RFID relay tag prior to transmitting the sensor data from the RFID relay tag in at least one of a first band RF signal communication, a second band RF signal communication, or a combination thereof.

16. The system of claim 13, wherein the RFID relay tag is further configured to preprocess the obtained sensor data prior to transmitting the preprocessed sensor data from the RFID relay tag in at least one of a first band RF signal communication, a second band RF signal communication, or a combination thereof

17. The system of claim 13, wherein the RFID relay tag is configured to transmit the obtained sensor data from the RFID relay tag by a first band RF signal communication.

18. The system of claim 13, wherein the RFID relay tag is configured to transmit the obtained sensor data from the RFID relay tag by a second band RF signal communication.

19. The system of claim 18, wherein the first band RF signal communication has a communication range that is shorter than the communication range of the second band RF signal communication.

20. The system of claim 19, further comprising at least one remote receiver; and wherein the RFID relay tag is further configured to:
receive the first band RF signal communications containing the produced sensor data at the RFID relay tag from the at least one local sensor when the at least one local sensor is positioned at a first geographic location that is within first band signal communication range of the RFID relay tag and an associated object but that is not within first band signal communication range of a remote receiver that is positioned at a second geographic location; and
transmit the obtained sensor data from the RFID relay tag to the remote receiver in a second band RF signal communication when the second geographic location of the remote receiver is within second band signal communication range of the RFID relay tag and its associated object.

21. The system of claim 19, further comprising at least one remote receiver; and wherein the RFID relay tag is further configured to:
receive the first band RF signal communications containing the produced sensor data at the RFID relay tag from the at least one local sensor when the at one least one sensor is positioned at a first geographic location and the RFID relay tag and its associated object are positioned at a second geographic location, and when neither of the first or second geographic locations is within second band signal communication range of the remote receiver that is positioned at a third geographic location;
store the obtained sensor data in data storage circuitry on board the RFID relay tag;
retrieve the stored data from the data storage circuitry on board the RFID relay tag; and
transmit the retrieved sensor data in a second band RF signal communication from the RFID relay tag to the remote receiver positioned at the third geographic location when the third geographic location of the remote receiver is within second band signal communication range of a fourth location of the RFID relay tag and its associated object while the RFID relay tag is transmitting.

22. The system of claim 19, further comprising at least one tag interface device; and wherein the RFID relay tag is further configured to:
receive the first band RF signal communications containing the produced sensor data at the RFID relay tag from at least one local sensor positioned at a first geographic location when the RFID relay tag is positioned at a second geographic location with its associated object and when neither of the first or second geographic locations is within first band signal communication range of the tag interface device that is positioned at a third geographic location;
store the obtained sensor data in data storage circuitry on board the RFID relay tag;
retrieve the stored data from the data storage circuitry on board the RFID relay tag; and
transmit the retrieved sensor data in a first band RF signal communication from the RFID relay tag to the tag interface device positioned at the third geographic location when the third geographic location of the tag interface device is within first band signal communication range of a fourth geographic location of the RFID relay tag and its associated object while the RFID relay tag is transmitting.

23. A RFID communication system, comprising:
at least one sensor configured to produce sensor data; and
a radio frequency identification (RFID) relay tag configured to transmit a command signal from the RFID relay tag to the at least one sensor by a first band RF signal communication, the command signal being effective to alter operation of the at least one sensor;
wherein the first band is a multiple channel-based frequency band; and
wherein the RFID relay tag is configured to remain associated with an object as the object moves from one geographic location to another geographic location.

24. The system of claim 23, further comprising at least one tag interface device; and wherein the RFID relay tag is further configured to:
receive the command signal in a first band RF signal communication received at the RFID relay tag from a tag interface device positioned at a first geographic location while the RFID relay tag and its associated object are positioned at a second geographic location, and when neither of the first or second geographic locations is within first band signal communication range of the at least one sensor device that is positioned at a third geographic location;
store the received command signal in data storage circuitry on board the RFID relay tag;
retrieve the stored command signal from the data storage circuitry on board the RFID relay tag; and
transmit first band RF signal communications containing the retrieved command signal from the RFID relay tag to the at least one local sensor positioned at the third geographic location when the RFID relay tag is positioned with its associated object at a fourth geographic location that is within first band signal communication range of the third geographic location.
